(19) United States
(12) Patent Application Publication
(10) Pub. No.: US 2025/0133614 A1
(43) Pub. Date: Apr. 24, 2025

(54) PERIPHERAL CONNECTION USING LOCAL INFORMATION

(71) Applicant: QUALCOMM Incorporated, San Diego, CA (US)

(72) Inventors: Vishal AGARWAL, Bangalore (IN); Manish RAO, Bangalore (IN); Ravi SHEKHAR, Thubarahalli (IN); Mayank BATRA, Cambridge (GB)

(21) Appl. No.: 18/492,684

(22) Filed: Oct. 23, 2023

(51) Int. Cl. H04W 76/14; H04W 80/02

(52) U.S. Cl. CPC H04W 76/14; H04W 80/02

(57) ABSTRACT

Various aspects of the present disclosure generally relate to wireless communication. In some aspects, a first peripheral device may receive, at a controller layer from a host layer, a command for information from a second peripheral device associated with the first peripheral device. The first peripheral device may provide, from the controller layer to the host layer, the information from local information stored at the first peripheral device. Numerous other aspects are described.

### FIELD OF THE DISCLOSURE

Aspects of the present disclosure generally relate to wireless communication and to techniques and apparatuses associated with peripheral device connections.

### BACKGROUND

A wireless personal area network (WPAN) is a short-range wireless network typically established by a user to interconnect various personal devices, sensors, and/or appliances located within a certain distance or area of the user. For example, a WPAN based on a communication protocol such as a Bluetooth® (BT) protocol, a Bluetooth Low Energy (BLE) protocol, or a Zigbee® protocol may provide wireless connectivity to peripheral devices that are within a specific distance (e.g., 5 meters, 10 meters, 20 meters, 100 meters) of each other. Bluetooth is a short-range wireless communication protocol that supports a WPAN between a central device (such as a host device or a source device) and at least one peripheral device (such as a client device or a sink device). However, power consumption associated with Bluetooth communications that operate on a basic rate (BR) and/or enhanced data rate (EDR) physical layer may render WPAN communication impractical in certain applications.

Accordingly, to address the power consumption challenges associated with Bluetooth BR/EDR (sometimes referred to as a Bluetooth classic or Bluetooth legacy protocol), Bluetooth Low Energy (BLE) (also referred to herein as WPAN LE) was developed and adopted in various applications in which data transfers are relatively infrequent and/or to enable WPAN communication with low power consumption. For example, BLE exploits infrequent data transfer by using a low duty cycle operation and placing one or both of the central device and the peripheral device(s) into a sleep mode between data transmissions, thereby conserving power. Example applications that use BLE include battery-operated sensors and actuators in various medical, industrial, consumer, and fitness applications. BLE may also be used to connect devices such as BLE-enabled smartphones, tablets, laptops, earbuds, or the like. While traditional (or classic) Bluetooth and BLE offer certain advantages, there exists a need for further improvements in Bluetooth and BLE technology. For example, traditional Bluetooth and BLE have a limited range, have a limited data capacity throughput, and are susceptible to interference from other devices communicating in the same frequency band (such as via wireless local area network (WLAN) communications).

### SUMMARY

Some aspects described herein relate to a method of wireless communication performed by a first peripheral device. The method may include receiving, at a controller layer from a host layer, a command for information from a second peripheral device associated with the first peripheral device. The method may include providing, from the controller layer to the host layer, the information from local information stored at the first peripheral device.

Some aspects described herein relate to a method of wireless communication performed by a first peripheral device. The method may include selecting, at a host layer, information that is an information type that is associated with matching information between the first peripheral device and a second peripheral device. The method may include providing, from the host layer to a controller layer, a command for the information from local information stored at the first peripheral device. The method may include receiving the information at the host layer from the controller layer.

Some aspects described herein relate to an apparatus for wireless communication at a first peripheral device. The apparatus may include one or more memories and one or more processors coupled to the one or more memories. The one or more processors may be individually or collectively configured to receive, at a controller layer from a host layer, a command for information from a second peripheral device associated with the first peripheral device. The one or more processors may be individually or collectively configured to provide, from the controller layer to the host layer, the information from local information stored at the first peripheral device.

Some aspects described herein relate to an apparatus for wireless communication at a first peripheral device. The apparatus may include one or more memories and one or more processors coupled to the one or more memories. The one or more processors may be individually or collectively configured to select, at a host layer, information that is an information type that is associated with matching information between the first peripheral device and a second peripheral device. The one or more processors may be individually or collectively configured to provide, from the host layer to a controller layer, a command for the information from local information stored at the first peripheral device. The one or more processors may be individually or collectively configured to receive the information at the host layer from the controller layer.

Some aspects described herein relate to a non-transitory computer-readable medium that stores a set of instructions for wireless communication by a first peripheral device. The set of instructions, when executed by one or more processors of the first peripheral device, may cause the first peripheral device to receive, at a controller layer from a host layer, a command for information from a second peripheral device associated with the first peripheral device. The set of instructions, when executed by one or more processors of the first peripheral device, may cause the first peripheral device to provide, from the controller layer to the host layer, the information from local information stored at the first peripheral device.

Some aspects described herein relate to a non-transitory computer-readable medium that stores a set of instructions for wireless communication by a first peripheral device. The set of instructions, when executed by one or more processors of the first peripheral device, may cause the first peripheral device to select, at a host layer, information that is an information type that is associated with matching information between the first peripheral device and a second peripheral device. The set of instructions, when executed by one or more processors of the first peripheral device, may cause the first peripheral device to provide, from the host layer to a controller layer, a command for the information from local information stored at the first peripheral device. The set of instructions, when executed by one or more processors of the first peripheral device, may cause the first peripheral device to receive the information at the host layer from the controller layer.

Some aspects described herein relate to an apparatus for wireless communication. The apparatus may include means for receiving, at a controller layer from a host layer, a command for information from a peripheral device associated with the apparatus. The apparatus may include means for providing, from the controller layer to the host layer, the information from local information stored at the apparatus.

Some aspects described herein relate to an apparatus for wireless communication. The apparatus may include means for selecting, at a host layer, information that is an information type that is associated with matching information between the apparatus and a peripheral device. The apparatus may include means for providing, from the host layer to a controller layer, a command for the information from local information stored at the apparatus. The apparatus may include means for receiving the information at the host layer from the controller layer.

Aspects generally include a method, apparatus, system, computer program product, non-transitory computer-readable medium, user equipment, base station, network entity, network node, central device, peripheral device, wireless communication device, access point, mobile station, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless personal area network (WPAN), in accordance with the present disclosure.

FIG. 2 is a diagram illustrating an example of a wireless communication device, in accordance with the present disclosure.

FIG. 3 is a diagram illustrating an example of a protocol stack, in accordance with the present disclosure.

FIG. 4 is a diagram illustrating an example transmission of a data packet from a wireless communication device to a peripheral device over a WPAN connection, in accordance with the present disclosure.

FIG. 5 is a diagram illustrating an example of a wireless communication device, in accordance with the present disclosure.

FIG. 6 is a diagram illustrating examples of audio streams, in accordance with the present disclosure.

FIG. 7 is a diagram illustrating an example of link manager protocol messages, in accordance with the present disclosure.

FIG. 8 is a diagram illustrating an example of obtaining earbud information, in accordance with the present disclosure.

FIG. 9 is a diagram illustrating an example of obtaining information, in accordance with the present disclosure.

FIG. 10 is a diagram illustrating an example process performed, for example, at a first peripheral device or an apparatus of a first peripheral device, in accordance with the present disclosure.

FIG. 11 is a diagram illustrating an example process performed, for example, at a first peripheral device or an apparatus of a first peripheral device, in accordance with the present disclosure.

FIG. 12 is a diagram of an example apparatus for wireless communication, in accordance with the present disclosure.

### DETAILED DESCRIPTION

In a wireless personal area network (WPAN), such as a Bluetooth (BT) network or a Bluetooth Low Energy (BLE) network, wireless audio may stream from a central device (e.g., a handset, a smartphone) to multiple peripheral devices (e.g., a left earbud and a right earbud). A primary earbud may receive packets from a central device, such as a user equipment (UE), in a stream directed to the primary earbud. A secondary earbud, paired with the primary earbud, may receive its own stream or receive relayed packets from the primary earbud. In this way, stereo or spatial audio may be provided by the earbuds.

For a user of earbuds to have a good experience, the earbuds are to quickly connect to each other and the phone when the earbuds are pulled from the charging case or otherwise activated. Quicker connections allow for quicker streaming of audio for music, video, or a call. However, the connection between earbuds and the connection to the phone may involve multiple messages, such as link management protocol (LMP) messages. For example, a first earbud may, at a host layer, request information about a second earbud (remote information) as part of establishing a connection between the earbuds and the phone. The first earbud may transmit an LMP request message. The second earbud may respond with the remote information in an LMP response message. The second earbud may provide the remote information from the controller layer to the host layer.

There may be many LMP messages. For example, LMP messages may request and provide a version number, supported features, extended features, timing accuracy, channel classification, a channel quality driven data rate (CQDDR) auto rate, adaptive frequency hopping (AFH) information, proprietary features, a page scan mode, a packet type table, a maximum number of slots, a preferred rate, or a role switch. These messages consume signaling resources and time.

However, the earbuds may have the same firmware and thus already have the same information at the local level (at the same earbud). According to various aspects described herein, a first earbud may use local information as the information that would be requested from the other earbud. The local information may be of an information type that is associated with matching information between the earbuds (same information for both earbuds). The first earbud may determine to refrain from transmitting an LMP request message. By not sending LMP messages for information that can be expected to be the same at both earbuds, the first earbud may conserve signaling messages and reduce latency as the earbuds connect to each other and the phone.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

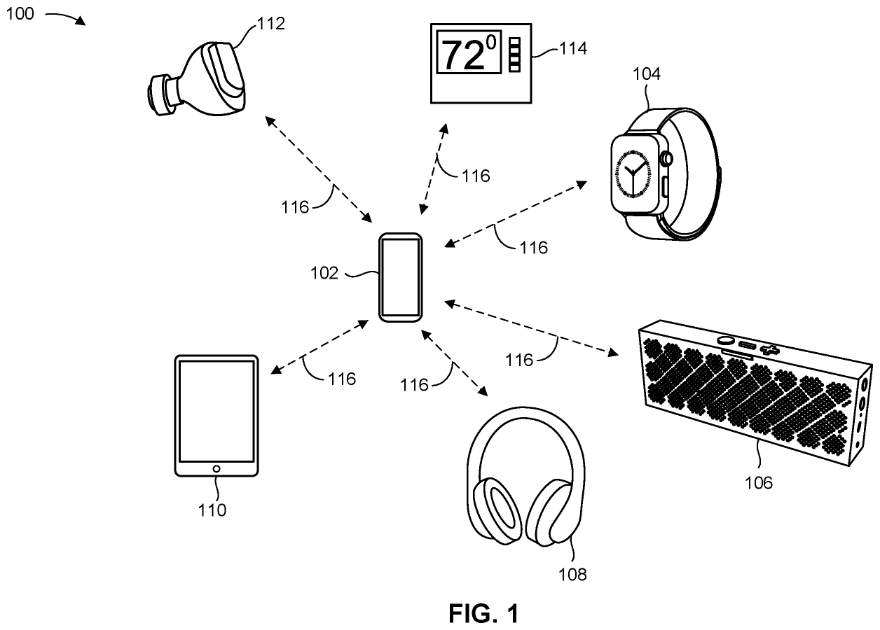

FIG. 1 is a diagram illustrating an example of a WPAN 100, according to some implementations. Within the WPAN 100, a central device 102 (which may be referred to herein as a source device or using other suitable terminology) may connect to and may establish a communication link 116 with one or more peripheral devices, such as a smartwatch 104, a Bluetooth portable speaker 106, wireless headphones 108, a tablet 110, a wireless earbud 112, and/or a smart appliance 114 (which may be referred to herein as sink devices or using other suitable terminology) using a BLE protocol or a modified BLE protocol. The BLE protocol is part of the BT core specification and enables radio frequency communication operating within the globally accepted 2.4 GHz Industrial, Scientific, and Medical (ISM) band.

In some aspects, as described herein, the central device 102 may include suitable logic, circuitry, interfaces, processors, and/or code that may be used to communicate with the one or more peripheral devices 104, 106, 108, 110, 112, and/or 114 using the BLE protocol or the modified BLE protocol. In some aspects, the central device 102 may operate as an initiator to request establishment of a link layer (LL) connection with an intended peripheral device 104, 106, 108, 110, 112, and/or 114. In some aspects, a link manager may be used to control operations between a WPAN application controller in the central device 102 and a WPAN application controller in each of the intended peripheral devices 104, 106, 108, 110, 112, and/or 114.

In some aspects, after a requested LL connection is established, the central device 102 may become a host device, and the selected or intended peripheral device 104, 106, 108, 110, 112, and/or 114 may become paired with the central device 102 over the established LL connection. As a host device, the central device 102 may support multiple concurrent LL connections with various peripheral devices 104, 106, 108, 110, 112, and/or 114 that are operating as client devices. For example, the central device 102 may manage various aspects of data packet communication in an LL connection with one or more associated peripheral devices 104, 106, 108, 110, 112, and/or 114. For example, the central device 102 may determine an operation schedule in the LL connection with one or more peripheral devices 104, 106, 108, 110, 112, and/or 114. The central device 102 may also initiate an LL protocol data unit (PDU) exchange sequence over the LL connection. LL connections may be configured to run periodic connection events in dedicated data channels. The exchange of LL data PDU transmissions between the central device 102 and one or more of the peripheral devices 104, 106, 108, 110, 112, and/or 114 may take place within connection events.

In some aspects, the central device 102 may be configured to transmit the first LL data PDU in each connection event to an intended peripheral device 104, 106, 108, 110, 112, and/or 114. Additionally, or alternatively, in some aspects, the central device 102 may utilize a polling scheme to poll the intended peripheral device 104, 106, 108, 110, 112, and/or 114 for an LL data PDU transmission during a connection event. The intended peripheral device 104, 106, 108, 110, 112, and/or 114 may transmit an LL data PDU upon receipt of a packet carrying an LL data PDU from the central device 102. In some other aspects, a peripheral device 104, 106, 108, 110, 112, and/or 114 may transmit an LL data PDU to the central device 102 without first receiving an LL data PDU from the central device 102.

Examples of the central device 102 may include a cellular phone, a smartphone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device (such as a smart watch or wireless headphones), a vehicle, a vehicle infotainment system or car kit, an electric meter, a gas pump, a toaster, a thermostat, a hearing aid, a blood glucose on-body unit, an Internet-of-Things (IoT) device, or the like.

Examples of the one or more peripheral devices 104, 106, 108, 110, 112, and/or 114 may include a cellular phone, a smartphone, an SIP phone, an STA, a laptop, a PC, a desktop computer, a PDA, a satellite radio, a global positioning system, a multimedia device, a video device, a digital audio player, a camera, a game console, a tablet, a smart device, a wearable device (e.g., a smart watch, wireless headphones, or wireless earbuds), a vehicle, a vehicle infotainment system or car kit, an electric meter, a gas pump, a toaster, a thermostat, a hearing aid, a blood glucose on-body unit, an IoT device, or the like. Although the central device 102 is illustrated in FIG. 1 as being in communication with six peripheral devices 104, 106, 108, 110, 112, and 114 in the WPAN 100, the central device 102 may communicate with more or fewer than six peripheral devices within the WPAN 100 without departing from the scope of the present disclosure.

In some aspects, a device implementing the BT protocol (e.g., the central device 102) may operate according to a first radio mode (e.g., a basic rate (BR)/enhanced data rate (EDR) radio mode), and a device implementing the BLE protocol may operate according to a second radio mode (e.g., the BLE radio mode). In some aspects, the central device 102 may be configured with dual radio modes, and therefore may be able to operate according to the BR/EDR mode or the BLE mode, for example, based on the type of short-range wireless communication in which the central device 102 may engage.

For example, in some aspects, the central device 102 may operate according to the BR/EDR mode for continuous streaming of data, for broadcast networks, for mesh networks, and/or for some other applications in which a relatively higher data rate may be more suitable. Additionally, or alternatively, the central device 102 may operate according to the BLE mode for short burst data transmissions, such as for some other applications in which power conservation may be desirable and/or a relatively lower data rate may be acceptable. Additionally, or alternatively, in some aspects, the central device 102 may operate according to one or more other radio modes, such as proprietary radio mode(s). Examples of other radio modes may include high speed radio modes, low energy radio modes, and/or isochronous radio modes, among other examples.

In some aspects, as described in more detail elsewhere herein, an assisting wireless device (e.g., among peripheral devices 104, 106, 108, 110, 112, and 114) may track a first retransmission metric that is based on a number of retransmitted packets that the assisting wireless device received from a source device, such as the central device 102. The assisting wireless device may receive, from a sink wireless device (e.g., among peripheral devices 104, 106, 108, 110, 112, and 114), an acknowledgement assistance request indicating a second retransmission metric for the sink wireless device. The assisting wireless device may transmit, to the sink wireless device, a response to the acknowledgement assistance request based on respective values of the first retransmission metric and the second retransmission metric. Additionally, or alternatively, the assisting wireless device may perform one or more other operations described herein.

In some aspects, as described in more detail elsewhere herein, a sink wireless device (e.g., among peripheral devices 104, 106, 108, 110, 112, and 114) may track a first retransmission metric that is based on a number of retransmitted packets that the sink wireless device received from a source device, such as the central device 102. The sink wireless device may transmit, to an assisting wireless device (e.g., among peripheral devices 104, 106, 108, 110, 112, and 114), an acknowledgement assistance request indicating the first retransmission metric tracked by the sink wireless device. The sink wireless device may receive, from the assisting wireless device, a response to the acknowledgement assistance request based on respective values of the first retransmission metric tracked by the sink wireless device and a second retransmission metric tracked by the assisting wireless device. Additionally, or alternatively, the sink wireless device may perform one or more other operations described herein.

As indicated above, FIG. 1 is provided as an example. Other examples may differ from what is described with regard to FIG. 1.

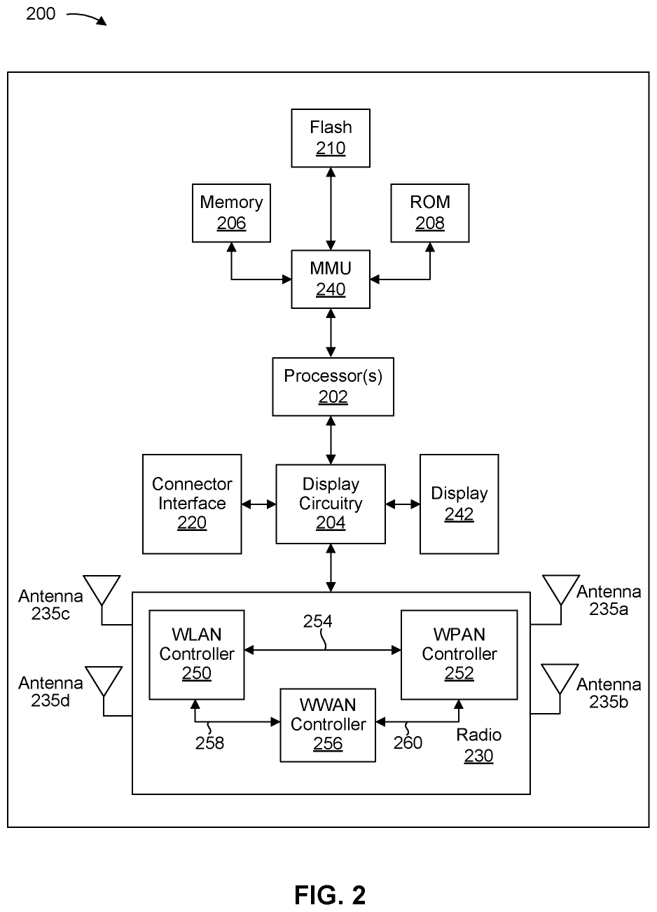

FIG. 2 is a diagram illustrating an example of a wireless communication device 200, in accordance with the present disclosure. In some aspects, the wireless communication device 200 may be an example of the central device 102 illustrated in FIG. 1. Additionally, or alternatively, the wireless communication device 200 may be an example of one or more of the peripheral devices 104, 106, 108, 110, 112, or 114 illustrated in FIG. 1. In some aspects, the wireless communication device 200 may be a Bluetooth-enabled device (such as a BLE device).

As shown in FIG. 2, the wireless communication device 200 may include a processing element, such as processor(s) 202, which may execute program instructions for the wireless communication device 200. The wireless communication device 200 may also include a display 242 that can perform graphics processing and present information to a user. The processor(s) 202 may also be coupled to a memory management unit (MMU) 240, which may be configured to receive addresses from the processor(s) 202 and translate the addresses to address locations in memory such as memory 206, ROM 208, or flash memory 210 and/or to address locations in other circuits or devices, such as display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless communication device 200. For example, the wireless communication device 200 may include various memory types, a connector interface 220 through which the wireless communication device 200 can communicate with a computer system, and wireless communication subsystems that can transmit data to, and receive data from, other devices based on one or more wireless communication standards or protocols. For example, in some aspects, the wireless communication subsystems may include (but are not limited to) a wireless local-area network (WLAN) subsystem, a WPAN subsystem, and/or a cellular subsystem (such as a Long-Term Evolution (LTE) or New Radio (NR) subsystem). The wireless communication device 200 may include multiple antennas 235a, 235b, 235c, and/or 235d for performing wireless communication with, for example, wireless communication devices in a WPAN. In some aspects, the WPAN may be an extended PAN (XPAN).

The wireless communication device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as an FPGA, and/or an application specific integrated circuit (ASIC).

In some aspects, the radio 230 may include separate controllers configured to control communications for various respective radio access technology (RAT) protocols. For example, as shown in FIG. 2, radio 230 may include a WLAN controller 250 that manages WLAN communications, a WPAN controller 252 that manages Bluetooth, BLE, and/or other suitable WPAN communications, and a wireless wide area network (WWAN) controller 256 that manages WWAN communications. In some aspects, the wireless communication device 200 may store and execute a WLAN software driver for controlling WLAN operations performed by the WLAN controller 250, a WPAN software driver for controlling WPAN operations performed by the WPAN controller 252, and/or a WWAN software driver for controlling WWAN operations performed by the WWAN controller 256.

In some aspects, a first coexistence interface 254 (such as a wired interface) may be used for sending information between the WLAN controller 250 and the WPAN controller 252. Additionally, or alternatively, in some aspects, a second coexistence interface 258 may be used for sending information between the WLAN controller 250 and the WWAN controller 256. Additionally, or alternatively, in some aspects, a third coexistence interface 260 may be used for sending information between the WPAN controller 252 and the WWAN controller 256.

In some aspects, one or more of the WLAN controller 250, the WPAN controller 252, and/or the WWAN controller 256 may be implemented as hardware, software, firmware, or any suitable combination thereof.

In some aspects, the WLAN controller 250 may be configured to communicate with a second device in a WPAN using a WLAN link using one or more, some, or all of the antennas 235a, 235b, 235c, and 235d. In other configurations, the WPAN controller 252 may be configured to communicate with at least one second device in a WPAN using one or more, some, or all of the antennas 235a, 235b, 235c, and 235d. In other configurations, the WWAN controller 256 may be configured to communicate with a second device in a WPAN using one or more, some, or all of the antennas 235a, 235b, 235c, and 235d. The WLAN controller 250, the WPAN controller 252, and/or the WWAN controller 256 may be configured to adjust a wakeup time interval and a shutdown time for the wireless communication device 200.

A short-range wireless communications protocol, such as BT, BLE, and/or BR/EDR, may include and/or may use one or more other communications protocols, for example, to establish and maintain communications links. Referring also to FIG. 1, the wireless communication device 200 may establish a communications link 116 with one or more peripheral devices, such as a wireless headset 112, according to at least one communications protocol for short-range wireless communications. In some aspects, the communications link 116 may include a communications link that adheres to a protocol included and/or for use with BT, BLE, BR/EDR, or the like. In one aspect, the communications link 116 may include an asynchronous connection-oriented logical (ACL) transport, sometimes referred to as an ACL link. When operating as an ACL link, the communications link 116 may allow the central device 102 (e.g., a source device) to connect or “pair” with a peripheral device, such as the headset 112. The connection is asynchronous in that the two devices may not need to synchronize, timewise, data communications between each other to permit communication of data packets via the communications link 116.

In some aspects, a logical link control and adaptation protocol (L2CAP) may be used within a BT protocol stack (not shown in FIG. 2 for simplicity). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In some aspects, the communications link 116 may include an advanced audio distribution profile (A2DP) link. For example, an A2DP link may provide a point-to-point link between a source device, such as the central device 102, and a sink device, such as the headset 112. With an A2DP link, data packets including audio may be transmitted over an ACL channel, and other information (e.g., for controlling the audio stream) may be transmitted over a separate control channel. The data packets may occur non-periodically.

In some aspects, the communications link 116 may support synchronous logical transport mechanisms between a source device (such as the central device 102) and a peripheral device (such as the headset 112). For example, the communications link 116 may include a synchronous connection-oriented (SCO) link that provides a symmetric point-to-point link between the source device and the peripheral device using time slots reserved for BT communications. In some aspects, an SCO link may not support retransmission of data packets, which may be unsatisfactory in audio streaming and/or voice call use cases in which a dropped audio or voice packet may reduce the quality of the user experience.

In some aspects, the communications link 116 may include an extended SCO (eSCO) link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice call use cases because a dropped audio or voice packet may be retransmitted, and therefore the probability of successfully receiving a data packet may be increased.

In some aspects, the communications link 116 shown in FIG. 1 may include an isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped, and the receiving device may continue to receive the stream without data from the dropped data packet.

In some aspects, a first peripheral device (e.g., wireless communication device 200, earbud, wearable device, portable speaker) includes means for receiving, at a controller layer from a host layer, a command for information from a second peripheral device associated with the first peripheral device; and/or means for providing, from the controller layer to the host layer, the information from local information stored at the first peripheral device. In some aspects, the means for the first peripheral device to perform operations described herein may include, for example, one or more of a WPAN controller 252, memory 206, antenna 235, processor 202, and/or MMU 240.

In some aspects, the first peripheral device includes means for selecting, at a host layer, information that is an information type that is associated with matching information between the first peripheral device and a second peripheral device; means for providing, from the host layer to a controller layer, a command for the information from local information stored at the first peripheral device; and/or means for receiving the information at the host layer from the controller layer.

As indicated above, FIG. 2 is provided as an example. Other examples may differ from what is described with regard to FIG. 2.

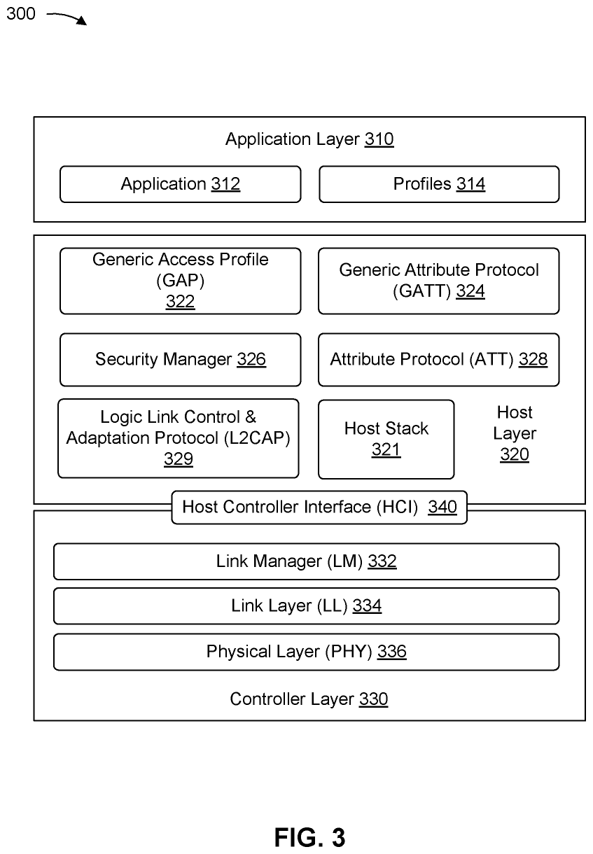

FIG. 3 is a diagram illustrating an example 300 of a protocol stack (e.g., a WPAN and/or a Bluetooth protocol stack), in accordance with the present disclosure. In some aspects, the protocol stack 300 may be implemented in a wireless communication device (such as the central device 102 or one or more of the peripheral devices 104, 106, 108, 110, 112, or 114 of FIG. 1). For example, the protocol stack 300 may be implemented by one or more of processor(s) 202, memory 206, flash memory 210, ROM 208, the radio 230, and/or the WPAN controller 252 illustrated in FIG. 2. In some aspects, the protocol stack 300 may be organized into three layers that include an application layer 310, a host layer 320, and a controller layer 330.

In some aspects, the application layer 310 may be a user application layer that interfaces with the other blocks and/or layers of the protocol stack 300. In some aspects, the application layer 310 may include one or more applications 312 and one or more Bluetooth profiles 314 that allow the one or more applications 312 to use Bluetooth and/or BLE communications. The host layer 320 may include the upper layers of the protocol stack 300, and may communicate with a controller (such as the WPAN controller 252 of FIG. 2) in a wireless communication device using a host controller interface (HCI) 340. In some aspects, the host layer 320 may include a host stack 321 that can be used for application layer interface management to allow an application 312 to access WPAN communications.

The controller layer 330 may include the lower layers of the protocol stack 300. In some aspects, the controller layer 330 may be used for hardware interface management, link establishment, and link management. As shown in FIG. 3, the controller layer 330 may include a link manager (LM) 332, a link layer 334, and a physical (PHY) layer 336. The PHY layer 336 may include, for example, a radio and/or a baseband processor. In some aspects, the PHY layer 336 may define a mechanism for transmitting a bit stream over a physical link or channel that connects WPAN devices. The bit stream may be grouped into code words or symbols, and may be converted to a data packet that is transmitted over a wireless transmission medium. The PHY layer 336 may provide an electrical, mechanical, and/or procedural interface to the wireless transmission medium. The PHY layer 336 may be responsible for modulation and demodulation of data into radio frequency (RF) signals for transmission over the air. The PHY layer 336 may describe the physical characteristics of a transmitter/receiver (or transceiver) included in a wireless communication device. The physical characteristics may include modulation characteristics, an RF tolerance, and/or a sensitivity level, among other examples.

In some aspects, the link layer 334 is responsible for low-level communication over the PHY layer 336. The link layer 334 may manage the sequence and timing for transmitting and receiving data packets, and using an LL protocol, communicates with other devices regarding connection parameters and data flow control. The link layer 334 also provides gatekeeping functionality to limit exposure and data exchange with other devices. If filtering is configured, the link layer 334 maintains a list of allowed devices and may ignore all requests for data exchange from devices not on the list of allowed devices. The link layer 334 may also reduce power consumption. In some aspects, the link layer 334 may include a proprietary LL that may be used to discover peer devices and establish a secure communication channel with the peer devices. In some aspects, the link layer 334 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The link manager 332 may be responsible for establishing and configuring links and managing power-change requests, among other tasks. Each type of logical link, such as ACL links, A2DP links, SCO links, eSCO links, ISO links, or the like, may be associated with a specific packet type. For example, an SCO link may provide reserved channel bandwidth for communication between a central device and a peripheral device, and may support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The link manager 332 may communicate with the host layer 320 using the HCI 340. In some aspects, the link manager 332 may translate commands associated with the HCI 340 into controller-level operations, such as baseband-level operations. The HCI 340 may act as a boundary between the lower layers (such as between the controller layer 330, the host layer 320, and the application layer 310). The BT specification may define a standard HCI to support BT systems that are implemented across two separate processors. For example, a BT system on a computer may use a processor of the BT system to implement the lower layers of the protocol stack 300, such as the PHY layer 336, the link layer 334, and/or the link manager 332, and may use a processor of a BT component to implement the other layers of the protocol stack 300, such as the host layer 320 and the application layer 310.

In FIG. 3, the host layer 320 is shown to include a generic access profile (GAP) 322, a generic attribute protocol (GATT) 324, a security manager (SM) 326, an attribute protocol (ATT) 328, and an L2CAP layer 329. The GAP 322 may provide an interface for an application 312 to initiate, establish, and manage connections with other WPAN (e.g., BT or BLE) devices. The GATT 324 may provide a service framework using the attribute protocol for discovering services, and for reading and writing characteristic values on a peer device. The GATT 324 may interface with the application 312, for example, through a profile which may define a collection of attributes and any permissions needed for the attributes to be used in BT or BLE communications.

The security manager 326 may be responsible for device pairing and key distribution. A security manager protocol implemented by the security manager 326 may define how communications with the security manager of a counterpart BLE device are performed. The security manager 326 provides additional cryptographic functions that may be used by other components of the protocol stack 300. The architecture of the security manager 326 used in WPAN communications is designed to minimize recourse requirements for peripheral devices by shifting work to a presumably more powerful central device. BLE uses a pairing mechanism for key distribution. The security manager 326 provides a mechanism to encrypt the data and a mechanism to provide data authentication.

The ATT 328 includes a client/server protocol based on attributes associated with a BLE device configured for a particular purpose. Examples may include monitoring heart rate, temperature, broadcasting advertisements, or the like. The attributes may be discovered, read, and written by peer devices. The set of operations which are executed over the ATT 328 may include error handling, server configuration, find information, read operations, write operations, and/or queued writes. The ATT 328 may form the basis of data exchange between BT and BLE devices.

The L2CAP layer 329 may be implemented above the HCI 340, and may communicate with the controller layer 330 through the HCI 340. The L2CAP layer 329 may be responsible for establishing connections across one or more existing logical links and for requesting additional links if none exist. The L2CAP layer 329 may also implement multiplexing between different higher-layer protocols, for example, to allow different applications to use a single link, such as a logical link, including an ACL link. In some implementations, the L2CAP layer 329 may encapsulate multiple protocols from the upper layers into a data packet format (and vice versa). The L2CAP layer 329 may also break packets with a large data payload from the upper layers into multiple packets with the data payload segmented into smaller size data payloads that fit into a maximum payload size (for example, twenty-seven (27) bytes) on the transmit side.

In some standards and protocols, such as BLE and/or BR/EDR, the central device 102 may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet, and failure of MIC validation may indicate that another packet has not been received (although failure of CRC validation may also indicate that another packet has not been received, and/or failure of MIC validation may also indicate one or more errors in a received packet).

CRC validation and MIC validation may be based on generating CRC values and MICs, respectively, based on received packets and respectively comparing those generated CRC values and MICs to CRC values and MICs included in the received packets. Specifically, a receiving device, such as the headset 112, that receives a packet may first generate a CRC value or a CRC checksum based on the received packet, such as based on a payload and, if applicable, an MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines that the received packet fails CRC validation, then the received packet may include errors and/or may be corrupted. In one configuration, the receiving device may discard the received packet that fails CRC validation. Alternatively, in another configuration, the receiving device may attempt to recover the received packet, for example, using one or more error correction techniques.

If the received packet is encrypted and passes CRC validation, then the receiving device may decrypt the received packet to obtain a decrypted payload and a decrypted MIC. For MIC validation, the receiving device may generate an MIC based on the decrypted payload and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset 112.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation. Alternatively, in another configuration, the receiving device may attempt to recover the received packet.

As indicated above, FIG. 3 is provided as an example. Other examples may differ from what is described with regard to FIG. 3.

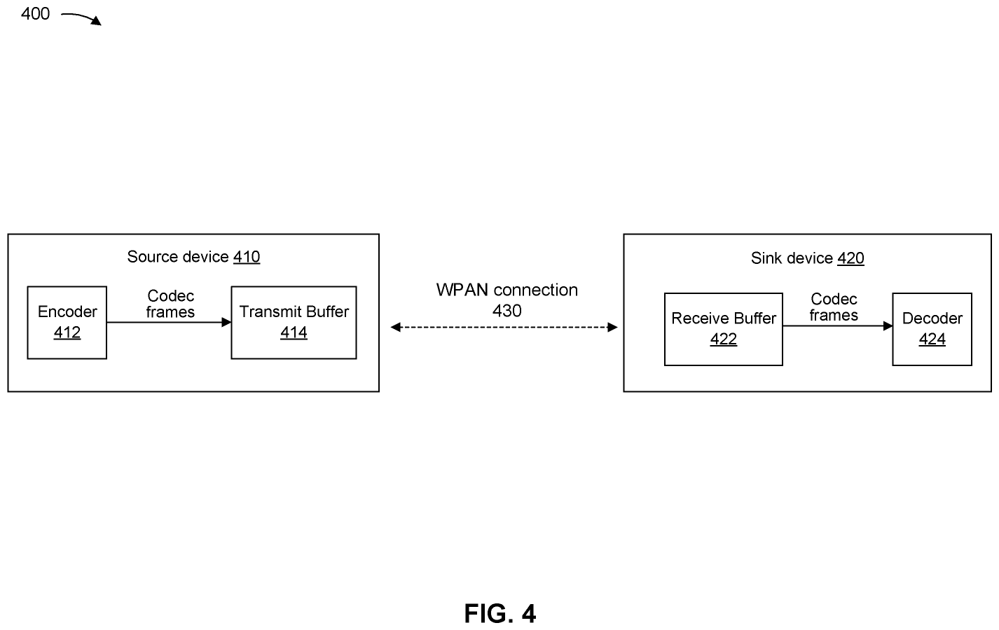

FIG. 4 is a diagram illustrating an example transmission 400 of a data packet from a source device 410 to a sink device 420 over a WPAN connection 430, according to the present disclosure. In some aspects, the source device 410 may be one example of the central device 102 in FIG. 1 and/or the wireless communication device 200 in FIG. 2, and the sink device 420 may be an example of one or more of the peripheral devices 104, 106, 108, 110, 112 or 114 in FIG. 1. In some aspects, the sink device 420 may be a wireless earbud, a pair of wireless earbuds, a wireless portable speaker, or another suitable device. The WPAN connection 430 may be any suitable Bluetooth or BLE connection or link. In some instances, the WPAN connection 430 may be one or more of an ACL link, an L2CAP link, an A2DP link, an SCO link, or an ISO link.

As shown in FIG. 4, the source device 410 may include an encoder 412 and a transmit buffer 414. The encoder 412 may be configured to encode data, such as audio or video data, using a specified bitrate. The transmit buffer 414 may be configured to queue data packets that are to be transmitted over the WPAN connection 430 to the sink device 420. In some implementations, the data packets to be transmitted over the WPAN connection 430 may have a predefined size, for example, based on the type of WPAN connection 430 and/or channel conditions associated with the WPAN connection 430. In some aspects, data encoded by the encoder 412 may be packetized into a data packet of a predefined size. The source device 410 may de-queue data packets from the transmit buffer 414 and transmit the data packets to the sink device 420 over the WPAN connection 430.

As further shown in FIG. 4, the sink device 420 may include a receive buffer 422 and a decoder 424. Data packets that the sink device 420 receives over the WPAN connection 430 may be queued or otherwise stored in the receive buffer 422. The data packets may be output from the receive buffer 422 and forwarded to the decoder 424. In some aspects, the decoder 424 may decode data (such as audio and/or video data) carried in the payloads of the queued data packets, and forward the decoded data to upper layers of the protocol stack for processing and playback to a user. In some implementations, the encoder 412 may encode a first encoder/decoder (codec) frame using a first bitrate and forward the first codec frame to the transmit buffer 414 to be packetized for transmission to the sink device 420 over the WPAN connection 430. The sink device 420 may queue the received data packet in the receive buffer 422 and may forward the first portion of the first codec frame to the decoder 424 for decoding.

As indicated above, FIG. 4 is provided as an example. Other examples may differ from what is described with regard to FIG. 4.

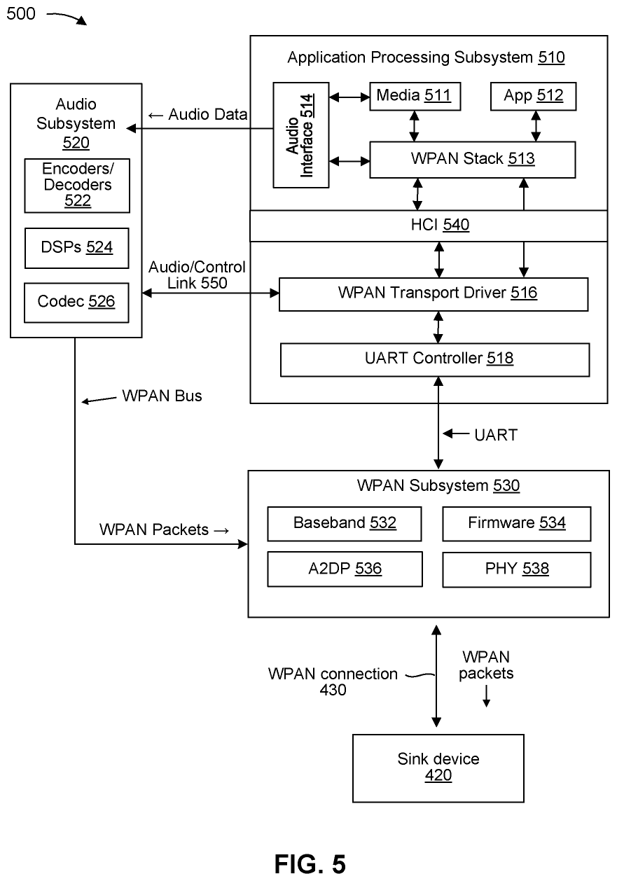

FIG. 5 is a diagram illustrating an example 500 of a wireless communication device 500, according to the present disclosure. In some aspects, the wireless communication device 500 may be an example of the central device 102 in FIG. 1, the wireless communication device 200 in FIG. 2, or the source device 410 in FIG. 4. In example 500, the wireless communication device 500 is depicted as having an established WPAN connection 430 (e.g., a Bluetooth communication connection) with the sink device 420 in FIG. 4.

The wireless communication device 500 may include an application processing subsystem 510, an audio subsystem 520, a WPAN subsystem 530, and an HCI 540. The application processing subsystem 510, which may correspond to at least some portions of the application layer 310 and the host layer 320 of the protocol stack 300 of FIG. 3, is shown to include a media player 511, an application layer 512, a WPAN stack 513, and an audio interface 514. The media player 511 can be any suitable device or component capable of generating or receiving multimedia content including, for example, real-time audio streams, real-time video streams, real-time gaming streams, and/or latency-sensitive traffic, among other examples. The application layer 512, which may be one implementation of the application layer 310 of FIG. 3, includes at least one Bluetooth profile that defines the collection of attributes and associated permissions to be used in Bluetooth or BLE communications. In some aspects, the application layer 512 may include processing resources including, for example, the memory 206, the ROM 208, and/or the flash memory 210 of FIG. 2. The WPAN stack 513 may be one implementation of the protocol stack 300 of FIG. 3.

In some aspects, as shown in FIG. 5, the application processing subsystem 510 may include a WPAN transport driver 516, which may include a split audio and packetization module (not shown for simplicity) that can packetize data (such as audio and/or video data) into Bluetooth frames that can be transmitted to the sink device 420 using a Bluetooth and/or BLE protocol. In some aspects, the WPAN transport driver 516 may be connected to the audio subsystem 520 via an audio and control link 550. In some aspects, the audio and control link 550 may be used to send encoded audio/video data and control signals between the WPAN transport driver 516 and audio/video DSPs within the audio subsystem 520. The WPAN transport driver 516 is also connected to a universal asynchronous receiver-transmitter (UART) controller 518 that provides controls for transmission of information via the WPAN connection 430.

The audio subsystem 520 may include encoders/decoders 522, one or more DSPs 524, and one or more codecs 526. The encoders/decoders 522 may be used to sample audio/video data extracted from one or more packets received from another wireless communication device. The extracted audio/video data may be processed in the application processing subsystem 510 based at least in part on the Bluetooth profile. In some implementations, the encoders/decoders 522 may partition the sampled audio/video data into payloads that can be embedded within one or more Bluetooth packets for transmission to the sink device 420 over the WPAN connection 430. In some instances, the DSPs 524 and/or the codecs 526 may employ one or more encoding or decoding algorithms in conjunction with sampling the audio data.

The WPAN subsystem 530 may include a baseband component 532 (e.g., a Bluetooth baseband component), a firmware component 534, an A2DP component 536, and a PHY component 538. The baseband component 532 and the firmware component 534 may be used to generate baseband signals for constructing and deconstructing data frames based on the Bluetooth or BLE protocol. The baseband component 532 and the firmware component 534 may also be used to generate carrier signals for up-converting baseband signals during data transmissions and for down-converting received data signals to baseband. The A2DP component 536 may be used to control or manage an A2DP link between the wireless communication device 500 and the sink device 420. Specifically, when the WPAN subsystem 530 is in a receive mode, the PHY component 538 can be used to receive, demodulate, and down-convert data packets received over the WPAN connection 430, and to forward the data packets to the application processing subsystem 510. When the WPAN subsystem 530 is in a transmit mode, the PHY component 538 can be used to encapsulate data provided from the upper layers into one or more Bluetooth frames or packets for transmission to the sink device 420 over the WPAN connection 430.

Communications may be target wake time (TWT)-based with synchronized end-to-end (E2E) timing. TWT involves the use of a schedule for waking up to communicate and powering down to conserve power.

As indicated above, FIG. 5 is provided as an example. Other examples may differ from what is described with regard to FIG. 5.

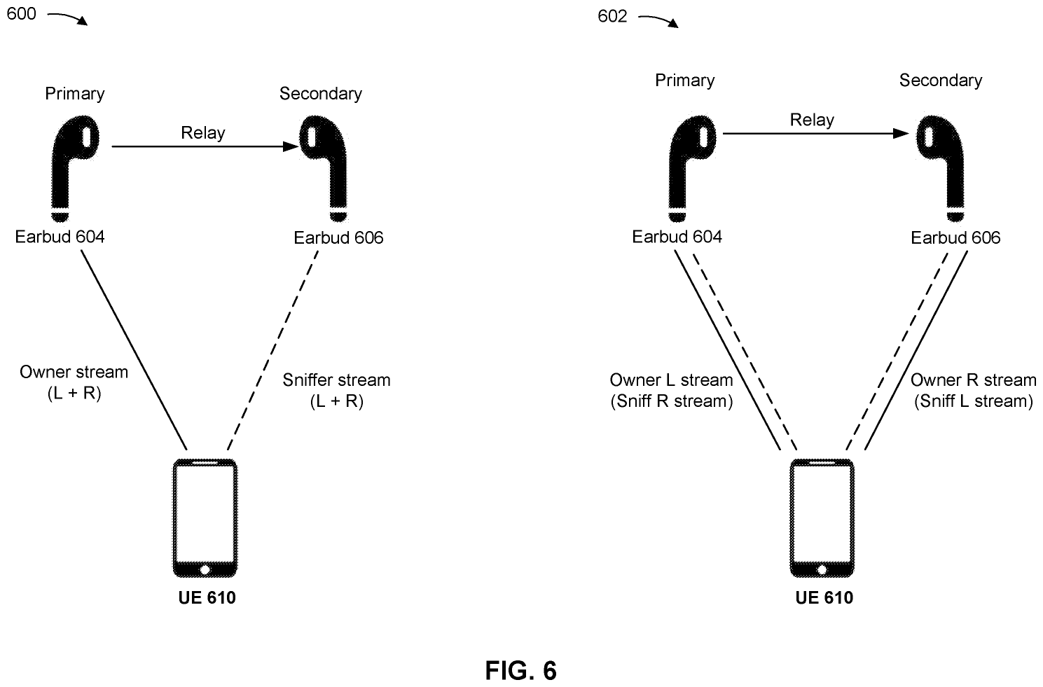

FIG. 6 is a diagram illustrating examples 600 and 602 of audio streams, in accordance with the present disclosure. Example 600 shows a UE 610 that operates with a first earbud 604 (e.g., peripheral device 110) and a second earbud 606 (e.g., peripheral device 110) that are paired together. UE 610 may support a peripheral link, such as a basic rate (BR)/enhanced data rate (EDR) Bluetooth® audio link (BREDR), a Bluetooth® low energy (BLE) link, an advanced audio distribution profile (A2DP) link, or a proprietary link with the first earbud 604 and/or the second earbud 606.

When UE 610 operates with the pair of earbuds 604 and 606, earbud 604 takes on a primary role (P-bud), and earbud 606 takes on a secondary role (S-bud). Note that either earbud may take on the primary role or the secondary role. Earbud 604, as a primary earbud in the primary role, may connect to UE 610 over a peripheral link (e.g., relay piconet), such as an A2DP link. Earbud 604 may connect to earbud 606 over a selective relay link. Earbud 606, as a secondary earbud in the secondary role, may sniff the link between UE 610 and earbud 604 to receive packets that use an audio/video distribution transport protocol (AVDTP) or an eSCO protocol. Earbud 604 and earbud 606 may use the relay piconet between them to relay voice data or microphone data. Earbud 606, in the secondary role, may not connect to UE 610 on a peripheral link. In some designs, earbud 604 may relay, to earbud 606, all of the audio data packets or all of the audio data packets that pertain to earbud 606 (e.g., right audio or left audio).

Voice pickup quality is highly challenged in an earbud form-factor. The two microphones in an earbud are far from the mouth and are physically close together, limiting a 2-microphone clear voice capture (CVC) algorithm approach to get best in class performance.

In some aspects, a secondary earbud (e.g., earbud 606) may transmit its microphone (MIC) data to a primary earbud (e.g., earbud 604). Earbud 604 may then combine its MIC data and earbud 606's MIC data, to construct an eSCO frame to send to a central device (e.g., UE 610). Using MIC data from both sides of the head is anticipated to improve the voice pickup performance, as there is a good degree of separation from the other microphones for providing improved noise suppression processing.

Earbud 604, the primary earbud that is directly getting the packets from the UE 610, providing acknowledgements (ACKs) for the packets, and responding to the UE 610 may be considered an owner earbud. Earbud 606 is considered to be a sniffer earbud because earbud 606 is the secondary earbud that is sniffing the packets from the UE 610 (stream not registered and not providing ACKs to the UE 610) and getting the missed packets from the owner bud.

Example 600 shows UE 610 transmitting joint stereo over ISO to earbud 604 as an owner A2DP stream with both a left earbud stream (L) and a right earbud stream (R), or an owner (L+R) stream. Earbud 606 is receiving packets for earbud 606 by a selective relay and sniffing the owner (L+R) stream. Both earbuds may receive L+R audio packets, and this allows for stereo audio and/or spatial audio. The earbuds may also use low energy (LE) connected ISO links for streaming.

Example 602 shows a scenario where each earbud receives its own stream. In some scenarios, each earbud can sniff the other stream. Packets that are missed may be relayed to the other earbud.

As indicated above, FIG. 6 is provided as an example. Other examples may differ from what is described with regard to FIG. 6.

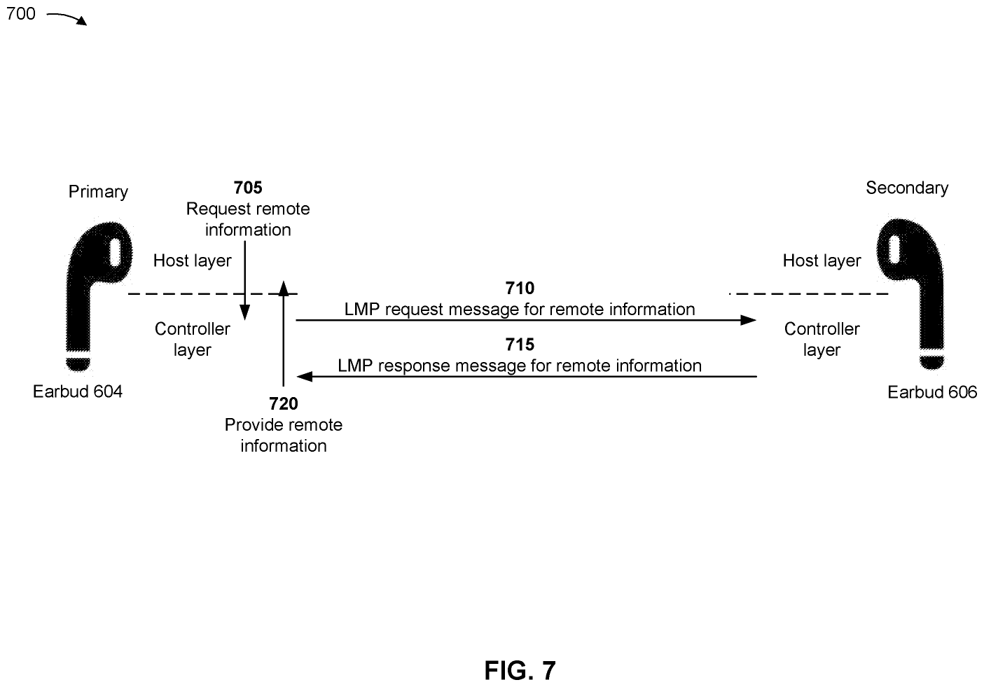

FIG. 7 is a diagram illustrating an example 700 of LMP messages, in accordance with the present disclosure.

In one scenario, both of the earbuds are powered off in a charging case. Both earbuds are taken out of the charging case. The earbuds connect with each other. After the earbuds are connected, the earbuds connect with the central device (e.g., phone). Once the phone is connected, the phone starts streaming audio.

In another scenario, a first earbud is removed from the charging case and connects to the phone. The second earbud is in the charging case. The phone is streaming audio to the first earbud. The second earbud is taken out of the charging case. The second earbud connects to the first earbud and starts streaming audio.

For a user of the earbuds to have a good experience, the earbuds are to quickly connect to each other and the phone when the earbuds are pulled from the charging case or otherwise activated. Quicker connections allow for quicker streaming of audio for music, video, or a call. If the earbuds connect to each other and the phone in parallel, traffic on a buddy link between the earbuds can result in less bandwidth that is available for paging to the phone. This may delay when the earbuds are streaming audio.

The connection between earbuds and the connection to the phone may involve multiple messages, such as LMP messages. For example, as shown by reference number 705, earbud 604 may, at a host layer, request information about earbud 606 (remote information) as part of establishing a connection between the earbuds and the phone. The host layer may include a higher layer at earbud 604 that is associated with an application at earbud 604. As shown by reference number 710, earbud 604 may transmit an LMP request message. As shown by reference number 715, earbud 606 may respond with the remote information in an LMP response message. As shown by reference number 720, earbud 604 may provide the remote information from the controller layer to the host layer. The controller layer may be associated with storing firmware information and with using physical layers for transmitting and receiving messages.

There may be many LMP messages. For example, LMP messages may request and provide a version number, supported features, extended features, timing accuracy, channel classification, a CQDDR auto rate, an AFH, proprietary features, a page scan mode, a packet type table, a maximum number of slots, a preferred rate, or a role switch. These messages consume signaling resources and time.

As indicated above, FIG. 7 is provided as an example. Other examples may differ from what is described with regard to FIG. 7.

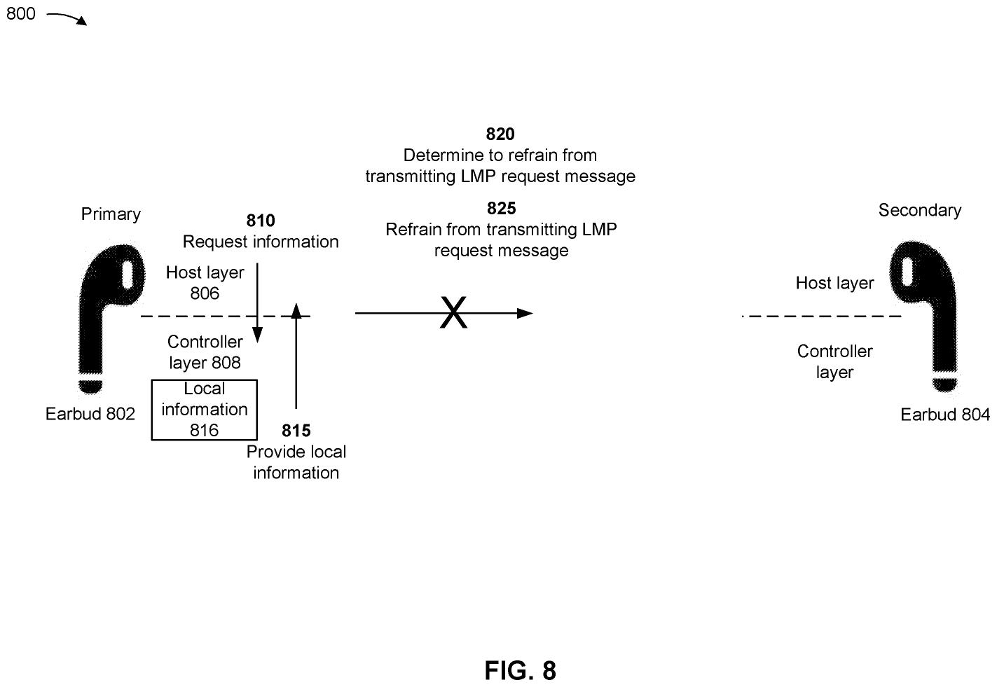

FIG. 8 is a diagram illustrating an example 800 of obtaining earbud information, in accordance with the present disclosure. Earbud 802 (e.g., wireless communication device 200, first peripheral device, primary earbud, owner earbud) may communicate with earbud 804 (e.g., wireless communication device 200, second peripheral device, secondary earbud, sniffer earbud). Earbud 802 and/or earbud 804 may communicate with a central device (e.g., UE, phone).

The earbuds may use multiple LMP messages to request and receive information about the other earbud. However, the earbuds may have the same firmware and thus already have the same information at the local level (at the same earbud). According to various aspects described herein, a first earbud may use local information as the information that would be requested from the other earbud. The local information may be of an information type that is associated with matching information between the earbuds (same information for both earbuds). The first earbud may determine to refrain from transmitting an LMP request message. By not sending LMP messages for information that can be expected to be the same at both earbuds, the first earbud may conserve signaling messages and reduce latency as the earbuds connect to each other and the phone.

Example 800 shows the use of local information rather than requesting remote information. As shown by reference number 810, a host layer 806 of earbud 802 may request information about earbud 804 (command to obtain remote information). As shown by reference number 815, a controller layer 808 of earbud 802 may provide the information from local information 816.

Earbud 802 may select to the local information for information that is of an information type that is associated with matching information between the earbuds (e.g., matched information type). Information that is associated with the matched information type may include information that is expected to be matched or the same at both earbuds due to the use of the same firmware or the same configuration. Such information may include, for example, Bluetooth version, supported features, supported extended features, timing accuracy, or a data rate (e.g., enabling of a CQDDR auto rate). The information of the information type may also include channel classification information, proprietary features, or L2CAP channel information.

As the local information is expected to be the same between the earbuds, earbud 802 may determine to refrain from transmitting an LMP request message for information of the matched information type, as shown by reference number 820. As shown by reference number 825, earbud 802 may refrain from transmitting an LMP message for the information of the matched information type. Earbud 802 may use LMP messages to request information not of the matched information type, such as a set AFH, a maximum number of slots, a packet type table, a page scan mode, and/or a preferred rate.

In some aspects, earbud 802 may establish a plurality of L2CAP channels (e.g., 3 L2CAP channels) between the earbuds. Each channel establishment takes a certain amount of time, such as 20 milliseconds (ms). The earbud 802 may have a preconfigured quantity of L2CAP channels (e.g., L2CAP signaling not expected) when the connection between the earbuds is established (e.g., with a fixed channel identifier (CID)), earbud 602 may save, for example, 60 ms at the time of connection. Each L2CAP channel may use a source CID and a destination CID. L2CAP channels may be readily available for any transactions without performing over the air transactions or signaling,

In some aspects, LL messages may be saved in the context of an LE connection. For example, information of the matched information type that may not be requested from the other earbud may include a link layer current supported feature set (FeatureSet), link layer version information, sleep clock accuracy, a proprietary feature mask, and/or a channel classification. The channel classification may include reporting that is enabled by default with a minimum spacing (e.g., 5) and a maximum delay (e.g., 5).

By reducing the LMP transactions and/or the L2CAP transactions, bandwidth can be given to paging or any other activity occurring at the phone. The bandwidth saved can be used for the other links, especially for the A2DP use case. Scenarios like A2DP LL and lossless modes can benefit due to the increased available bandwidth.

In some aspects, an earbud application may know about the Bluetooth device address (e.g., BDAddress) of both of the earbuds. The BDAddress may be used for identifying the earbuds and implementing the above methods on that link. For the controller, there may be a vendor command, such as SET_PRIMARY_SECONDARY_BD_ADDRS (Section Volume 3: Part A: QHCI 3.11.16), which may take in the address of the earbuds. This vendor specific command may be reused for this purpose. An L2CAP channel may be automatically created with the specified CID and maximum transmit unit (MTU). That is, the L2CAP channels may be established without L2CAP signaling. The L2CAP channels may be preconfigured (e.g., what is the MTU).

In some aspects, a set of features (one or more features) may be enabled by default. Such features may be important features that are always enabled by remote. For example, earbud 802 and 804 may enable the set of features by default rather than by using LMP messages.

As indicated above, FIG. 8 is provided as an example. Other examples may differ from what is described with regard to FIG. 8.

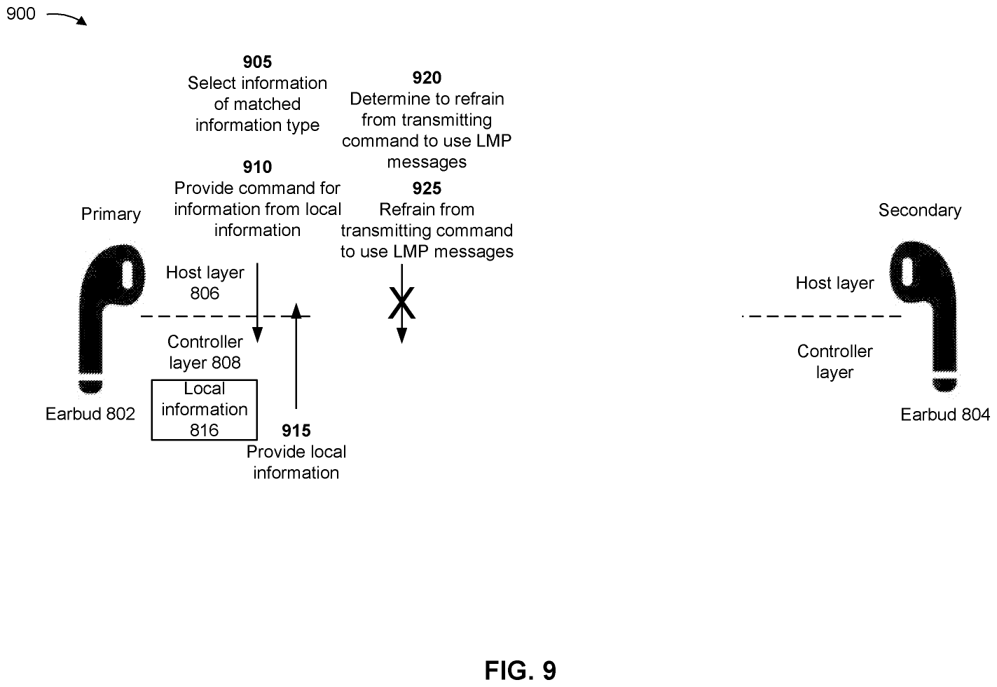

FIG. 9 is a diagram illustrating an example 900 of obtaining information, in accordance with the present disclosure.

In some aspects, the selection of local information may occur at the host layer. As shown by reference number 905, earbud 802, at the host layer 806, may select information of the matched information type. As shown by reference number 910, earbud 802, at the host layer 806, may provide a command to obtain information from local information rather than use LMP messages. As shown by reference number 915, earbud 802, at the controller layer 808, may provide the local information. This may include determining, as the host layer 806, to refrain from transmitting a command to use LMP messages to obtain the information, as shown by reference number 920. As shown by reference number 925, earbud 802, at the host layer 806, may refrain from transmitting a command to use LMP messages to obtain the information.

By being selective at the host layer 806, when transmitting commands to use LMP messages for information that is matched between the earbuds, earbud 802 may conserve signaling messages and reduce the latency of a connection.

As indicated above, FIG. 9 is provided as an example. Other examples may differ from what is described with regard to FIG. 9.

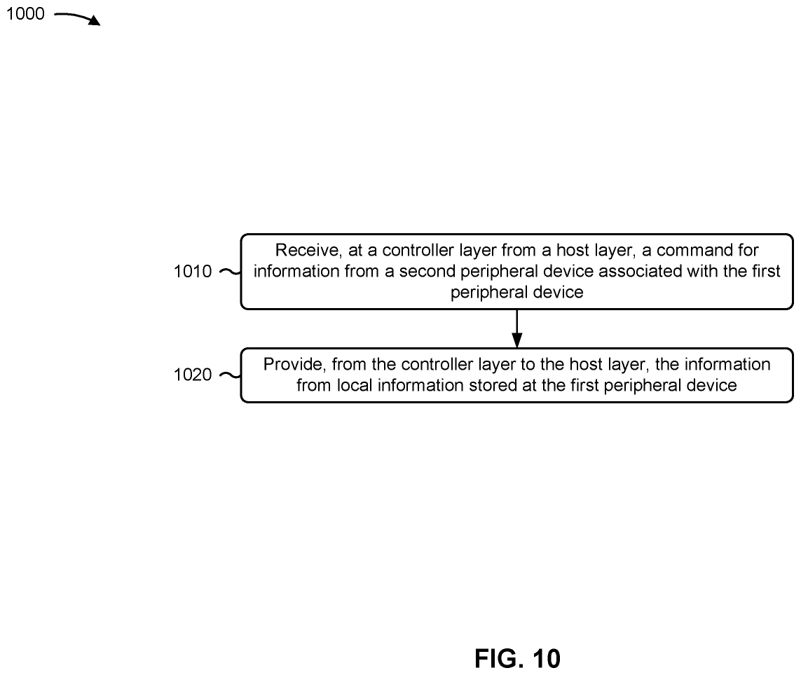

FIG. 10 is a diagram illustrating an example process 1000 performed, for example, at a first peripheral device or an apparatus of a first peripheral device, in accordance with the present disclosure. Example process 1000 is an example where the apparatus or the first peripheral device (e.g., wireless communication device 200, first peripheral device, earbud 802) performs operations associated with establishing a peripheral connection using local information.

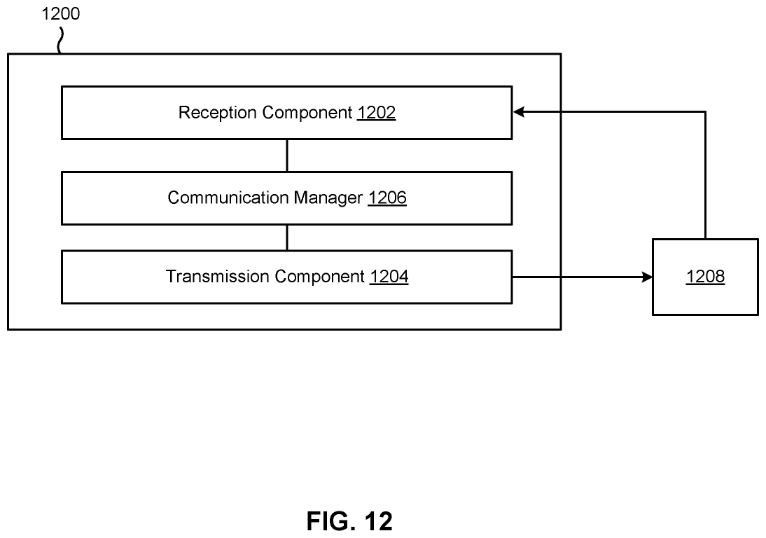

As shown in FIG. 10, in some aspects, process 1000 may include receiving, at a controller layer from a host layer, a command for information from a second peripheral device associated with the first peripheral device (block 1010). For example, the first peripheral device (e.g., using reception component 1202 and/or communication manager 1206, depicted in FIG. 12) may receive, at a controller layer from a host layer, a command for information from a second peripheral device associated with the first peripheral device, as described above.

As further shown in FIG. 10, in some aspects, process 1000 may include providing, from the controller layer to the host layer, the information from local information stored at the first peripheral device (block 1020). For example, the first peripheral device (e.g., using communication manager 1206, depicted in FIG. 12) may provide, from the controller layer to the host layer, the information from local information stored at the first peripheral device, as described above.

Process 1000 may include additional aspects, such as any single aspect or any combination of aspects described below and/or in connection with one or more other processes described elsewhere herein.

In a first aspect, process 1000 includes refraining from transmitting a request to the second peripheral device for the information in a link manager protocol (LMP) message.

In a second aspect, alone or in combination with the first aspect, providing the information includes selecting information that is an information type that is associated with matching information between the first peripheral device and the second peripheral device.

In a third aspect, alone or in combination with one or more of the first and second aspects, the information is associated with establishing a connection with the second peripheral device at startup of the first peripheral device.

In a fourth aspect, alone or in combination with one or more of the first through third aspects, the local information includes version information.

In a fifth aspect, alone or in combination with one or more of the first through fourth aspects, the local information includes one or more of supported features or supported extended features.

In a sixth aspect, alone or in combination with one or more of the first through fifth aspects, the local information includes timing accuracy information.

In a seventh aspect, alone or in combination with one or more of the first through sixth aspects, the local information includes data rate information.

In an eighth aspect, alone or in combination with one or more of the first through seventh aspects, the local information includes channel classification information.

In a ninth aspect, alone or in combination with one or more of the first through eighth aspects, the local information includes information about proprietary link manager protocol features.

In a tenth aspect, alone or in combination with one or more of the first through ninth aspects, the local information includes L2CAP information.

In an eleventh aspect, alone or in combination with one or more of the first through tenth aspects, process 1000 includes establishing one or more L2CAP channels using the L2CAP information.

In a twelfth aspect, alone or in combination with one or more of the first through eleventh aspects, the local information includes link layer supported features.

In a thirteenth aspect, alone or in combination with one or more of the first through twelfth aspects, the local information includes link layer version information.

In a fourteenth aspect, alone or in combination with one or more of the first through thirteenth aspects, the local information includes sleep clock information.

In a fifteenth aspect, alone or in combination with one or more of the first through fourteenth aspects, the local information includes a link layer feature mask information.

In a sixteenth aspect, alone or in combination with one or more of the first through fifteenth aspects, process 1000 includes enabling a set of features by default.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

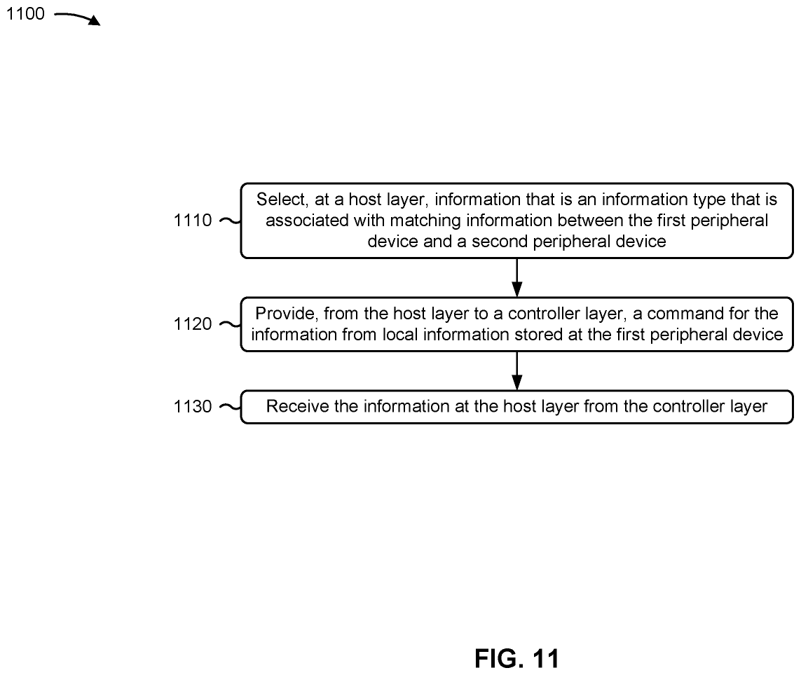

FIG. 11 is a diagram illustrating an example process 1100 performed, for example, at a first peripheral device or an apparatus of a first peripheral device, in accordance with the present disclosure. Example process 1100 is an example where the apparatus or the first peripheral device (e.g., wireless communication device 200, first peripheral device, earbud 802) performs operations associated with establishing a peripheral connection using local information.

As shown in FIG. 11, in some aspects, process 1100 may include selecting, at a host layer, information that is an information type that is associated with matching information between the first peripheral device and a second peripheral device (block 1110). For example, the first peripheral device (e.g., using communication manager 1206, depicted in FIG. 12) may select, at a host layer, information that is an information type that is associated with matching information between the first peripheral device and a second peripheral device, as described above.

As further shown in FIG. 11, in some aspects, process 1100 may include providing, from the host layer to a controller layer, a command for the information from local information stored at the first peripheral device (block 1120). For example, the first peripheral device (e.g., using communication manager 1206, depicted in FIG. 12) may provide, from the host layer to a controller layer, a command for the information from local information stored at the first peripheral device, as described above.

As further shown in FIG. 11, in some aspects, process 1100 may include receiving the information at the host layer from the controller layer (block 1130). For example, the first peripheral device (e.g., using reception component 1202 and/or communication manager 1206, depicted in FIG. 12) may receive the information at the host layer from the controller layer, as described above.

Process 1100 may include additional aspects, such as any single aspect or any combination of aspects described below and/or in connection with one or more other processes described elsewhere herein.

In a first aspect, process 1100 includes refraining from transmitting a command to request the information from the second peripheral device through LMP messages. The host layer may instead send the command to get the local information and duplicate the information for a second peripheral device.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a first peripheral device, or a first peripheral device may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the WPAN controller 252 described in connection with FIG. 2. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10, process 1100 of FIG. 11, or a combination thereof. In some aspects, the apparatus 1200 and/or one or more components shown in FIG. 12 may include one or more components of the first peripheral device described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the first peripheral device described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the first peripheral device described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

In some aspects, the reception component 1202 may receive, at a controller layer from a host layer, a command for information from a second peripheral device associated with the first peripheral device. The communication manager 1206 may provide, from the controller layer to the host layer, the information from local information stored at the first peripheral device.

The communication manager 1206 may refrain from transmitting a request to the second peripheral device for the information in an LMP message. The communication manager 1206 may establish one or more L2CAP channels using the L2CAP information. The communication manager 1206 may enable a set of features by default.

In some aspects, the communication manager 1206 may select, at a host layer, information that is an information type that is associated with matching information between the first peripheral device and a second peripheral device. The communication manager 1206 may provide, from the host layer to a controller layer, a command for the information from local information stored at the first peripheral device. The reception component 1202 may receive the information at the host layer from the controller layer.

The communication manager 1206 may refrain from transmitting a command to request the information from the second peripheral device through LMP messages.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first peripheral device, comprising: receiving, at a controller layer from a host layer, a command for information from a second peripheral device associated with the first peripheral device; and providing, from the controller layer to the host layer, the information from local information stored at the first peripheral device.

Aspect 2: The method of Aspect 1, further comprising refraining from transmitting a request to the second peripheral device for the information in a link manager protocol (LMP) message.

Aspect 3: The method of any of Aspects 1-2, wherein providing the information includes selecting information that is an information type that is associated with matching information between the first peripheral device and the second peripheral device.

Aspect 4: The method of any of Aspects 1-3, wherein the information is associated with establishing a connection with the second peripheral device at startup of the first peripheral device.

Aspect 5: The method of any of Aspects 1-4, wherein the local information includes version information.

Aspect 6: The method of any of Aspects 1-5, wherein the local information includes one or more of supported features or supported extended features.

Aspect 7: The method of any of Aspects 1-6, wherein the local information includes timing accuracy information.

Aspect 8: The method of any of Aspects 1-7, wherein the local information includes data rate information.

Aspect 9: The method of any of Aspects 1-8, wherein the local information includes channel classification information.

Aspect 10: The method of any of Aspects 1-9, wherein the local information includes information about proprietary link manager protocol features.

Aspect 11: The method of any of Aspects 1-10, wherein the local information includes logical link control adaptation protocol (L2CAP) information.

Aspect 12: The method of Aspect 11, further comprising establishing one or more L2CAP channels using the L2CAP information.

Aspect 13: The method of any of Aspects 1-12, wherein the local information includes link layer supported features.

Aspect 14: The method of any of Aspects 1-13, wherein the local information includes link layer version information.

Aspect 15: The method of any of Aspects 1-14, wherein the local information includes sleep clock information.

Aspect 16: The method of any of Aspects 1-15, wherein the local information includes a link layer feature mask information.

Aspect 17: The method of any of Aspects 1-16, further comprising enabling a set of features by default.

Aspect 18: A method of wireless communication performed by a first peripheral device, comprising: selecting, at a host layer, information that is an information type that is associated with matching information between the first peripheral device and a second peripheral device; providing, from the host layer to a controller layer, a command for the information from local information stored at the first peripheral device; and receiving the information at the host layer from the controller layer.

Aspect 19: The method of Aspect 18, further comprising refraining from transmitting a command to request the information from the second peripheral device through link manager protocol (LMP) messages.

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 21: An apparatus for wireless communication at a device, the apparatus comprising one or more memories and one or more processors coupled to the one or more memories, the one or more processors configured to cause the device to perform the method of one or more of Aspects 1-19.

Aspect 22: An apparatus for wireless communication, the apparatus comprising at least one means for performing the method of one or more of Aspects 1-19.

Aspect 23: A non-transitory computer-readable medium storing code for wireless communication, the code comprising instructions executable by one or more processors to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

Aspect 25: A device for wireless communication, the device comprising a processing system that includes one or more processors and one or more memories coupled with the one or more processors, the processing system configured to cause the device to perform the method of one or more of Aspects 1-19.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first peripheral device, comprising:
one or more memories; and
one or more processors, coupled to the one or more memories, individually or collectively configured to cause the first peripheral device to:
receive, at a controller layer from a host layer, a command for information from a second peripheral device associated with the first peripheral device; and
provide, from the controller layer to the host layer, the information from local information stored at the first peripheral device.

2. The apparatus of claim 1, wherein the one or more processors are individually or collectively configured to cause the first peripheral device to refrain from transmitting a request to the second peripheral device for the information in a link manager protocol (LMP) message.

3. The apparatus of claim 1, wherein to provide the information, the one or more processors are individually or collectively configured to cause the first peripheral device to select information that is an information type that is associated with matching information between the first peripheral device and the second peripheral device.

4. The apparatus of claim 1, wherein the information is associated with establishing a connection with the second peripheral device at startup of the first peripheral device.

5. The apparatus of claim 1, wherein the local information includes version information.

6. The apparatus of claim 1, wherein the local information includes supported features or supported extended features.

7. The apparatus of claim 1, wherein the local information includes timing accuracy information.

8. The apparatus of claim 1, wherein the local information includes data rate information.

9. The apparatus of claim 1, wherein the one or more processors are individually or collectively configured to cause the first peripheral device to channel classification information.

10. The apparatus of claim 1, wherein the local information includes information about proprietary link manager protocol features.

11. The apparatus of claim 1, wherein the local information includes logical link control adaptation protocol (L2CAP) information.

12. The apparatus of claim 11, wherein the one or more processors are individually or collectively configured to cause the first peripheral device to establish one or more L2CAP channels using the L2CAP information.

13. The apparatus of claim 1, wherein the one or more processors are individually or collectively configured to cause the first peripheral device to link layer supported features.

14. The apparatus of claim 1, wherein the one or more processors are individually or collectively configured to cause the first peripheral device to link layer version information.

15. The apparatus of claim 1, wherein the one or more processors are individually or collectively configured to cause the first peripheral device to sleep clock information.

16. The apparatus of claim 1, wherein the local information includes a link layer feature mask information.

17. The apparatus of claim 1, wherein the one or more processors are individually or collectively configured to cause the first peripheral device to enable a set of features by default.

18. An apparatus for wireless communication at a first peripheral device, comprising:
one or more memories; and
one or more processors, coupled to the one or more memories, individually or collectively configured to cause the first peripheral device to:
select, at a host layer, information that is an information type that is associated with matching information between the first peripheral device and a second peripheral device;
provide, from the host layer to a controller layer, a command for the information from local information stored at the first peripheral device; and
receive the information at the host layer from the controller layer.

19. The apparatus of claim 18, wherein the one or more processors are individually or collectively configured to cause the first peripheral device to refrain from transmitting a command to request the information from the second peripheral device through link manager protocol (LMP) messages.

20. A method of wireless communication performed by a first peripheral device, comprising:
receiving, at a controller layer from a host layer, a command for information from a second peripheral device associated with the first peripheral device; and
providing, from the controller layer to the host layer, the information from local information stored at the first peripheral device.

21. The method of claim 20, further comprising refraining from transmitting a request to the second peripheral device for the information in a link manager protocol (LMP) message.

22. The method of claim 20, wherein providing the information includes selecting information that is an information type that is associated with matching information between the first peripheral device and the second peripheral device.

23. The method of claim 20, wherein the information is associated with establishing a connection with the second peripheral device at startup of the first peripheral device.

24. The method of claim 20, wherein the local information includes logical link control adaptation protocol (L2CAP) information.

25. The method of claim 24, further comprising establishing one or more L2CAP channels using the L2CAP information.

26. The method of claim 20, further comprising enabling a set of features by default.

27. A method of wireless communication performed by a first peripheral device, comprising:
selecting, at a host layer, information that is an information type that is associated with matching information between the first peripheral device and a second peripheral device;
providing, from the host layer to a controller layer, a command for the information from local information stored at the first peripheral device; and
receiving the information at the host layer from the controller layer.

28. The method of claim 27, further comprising refraining from transmitting a command to request the information from the second peripheral device through link manager protocol (LMP) messages.
